(19) United States
(12) Patent Application Publication
(10) Pub. No.: US 2012/0083387 A1
(43) Pub. Date: Apr. 5, 2012

(54) REHEATED GAS TURBINE SYSTEM, IN PARTICULAR SUCH A SYSTEM HAVING A FUEL CELL

(75) Inventor: James William Griffith Turner, Wymondaham (GB)

(73) Assignee: LOTUS CARS LIMITED, Hethel, Norwich (GB)

(21) Appl. No.: 13/262,110

(22) PCT Filed: Mar. 30, 2010
(86) PCT No.: PCT/GB2010/000630

§ 371 Date: Dec. 12, 2011

(30) Foreign Application Priority Data
Mar. 30, 2009 (GB) 0905469.3

(51) Int. Cl. B60W 10/02; B60W 20/00; F02C 6/04

(52) U.S. Cl. 477/5; 60/784; 180/65.265

(57) ABSTRACT

The present invention relates to (with reference to FIG. 2) a gas turbine system comprising: a gas compressor (210); an upstream heat source, e.g. a fuel cell (212), which receives gas compressed by the compressor (210) and heats the gas passing therethrough (and when a fuel cell generates electrical power); an intermediate turbine (220) which receives the gas previously heated in the upstream heat source and which is connected to and drives the compressor (210); and an output turbine (240) which receives gas output by the intermediate turbine (220). Expanded gas leaving the intermediate turbine passes to the output turbine through either or both of a downstream combustion chamber and/or a downstream fuel cell, whereby the expanded gas is reheated prior to expansion in the output turbine (240). Preferably the system is configured such that the temperature of the gas received by the output turbine (240) is higher than the temperature of the gas received by the intermediate turbine (220).

The present invention relates to a reheated gas turbine system and, in particular, to such a system having a Fuel Cell.

Gas turbine systems are known in which a flow of gas between a compressor and a turbine is heated consecutively by a Solid Oxide Fuel Cell (SOFC) and then a combustion chamber.

According to a first aspect of the present invention, there is provided a gas turbine system comprising:

a compressor;

an upstream fuel cell which receives gas compressed by the compressor and which generates electrical power and heats the gas passing therethrough;

an intermediate turbine which receives the heated gas leaving the first fuel cell and which is connected to and drives the compressor; and

an output turbine which receives gas output by the intermediate stage; wherein:

expanded gas leaving the intermediate turbine passes to the output turbine through either or both of a downstream combustion chamber and/or a downstream fuel cell, whereby the expanded gas is reheated prior to expansion in the output turbine.

According to a second aspect of the present invention, there is provided a gas turbine system comprising:

a compressor;

an upstream combustion chamber which receives gas compressed by the compressor and which heats the gas passing therethrough;

an intermediate turbine which receives the heated gas leaving the first combustion chamber and which is connected to and drives the compressor; and

an output turbine which receives the gas output by the intermediate turbine stage; wherein

expanded gas leaving the intermediate turbine passes to the output turbine through a downstream fuel cell, whereby the expanded gas is reheated prior to expansion in the output turbine.

The present invention also relates to a reheated gas turbine system having different inlet temperatures at the inlet of the intermediate turbine and the inlet of the output turbine or output nozzle.

Gas turbine systems having a high pressure turbine for driving a high pressure compressor and a separate low pressure output turbine for driving an output shaft are known. Often, such turbine systems will further comprise an additional combustion chamber located in the flow path between the high pressure turbine and the low pressure output turbine.

Conventionally, such turbine systems will operate with the highest possible turbine inlet temperatures, at both the high pressure turbine and the output turbine, in order to achieve the highest possible efficiency. The inlet temperature of a turbine is limited by the physical properties of the materials from which the turbines are made. Accordingly, in order to ensure that the turbine system can operate at the highest possible efficiency, conventional turbines are manufactured to be able to withstand the highest temperatures possible. This is extremely costly as the turbines must be made from expensive materials to have as high a temperature resistance as possible.

According to a third aspect of the present invention, there is provided a gas turbine system comprising: a compressor; an upstream heat source which receives gas compressed by the compressor and which heats the gas passing therethrough; a high-pressure turbine which receives the heated gas leaving the upstream heat source and which is connected to and drives the compressor; a downstream combustion chamber which receives gas leaving the high-pressure turbine and which heats the gas passing therethrough; and an output turbine which receives gas output by the downstream combustion chamber, wherein: the system is configured such that the temperature of the gas received by the output turbine is higher than the temperature of the gas received by the high-pressure turbine.

According to a fourth aspect of the present invention, there is provided a method of operating a gas turbine system that comprises: a compressor; an upstream heat source which receives gas compressed by the compressor and which heats the gas passing therethrough; a high-pressure turbine which receives the heated gas leaving the upstream heat source and which is connected to and drives the compressor; a downstream combustion chamber which receives gas leaving the high-pressure turbine and which heats the gas passing therethrough; and an output turbine which receives gas output by the downstream combustion chamber; wherein the temperature of the gas received by the output turbine is controlled to be different from the temperature of the gas received by the high-pressure turbine by a predetermined amount.

The present invention will now be described, by way of example only, with reference to the accompanying drawings, in which:

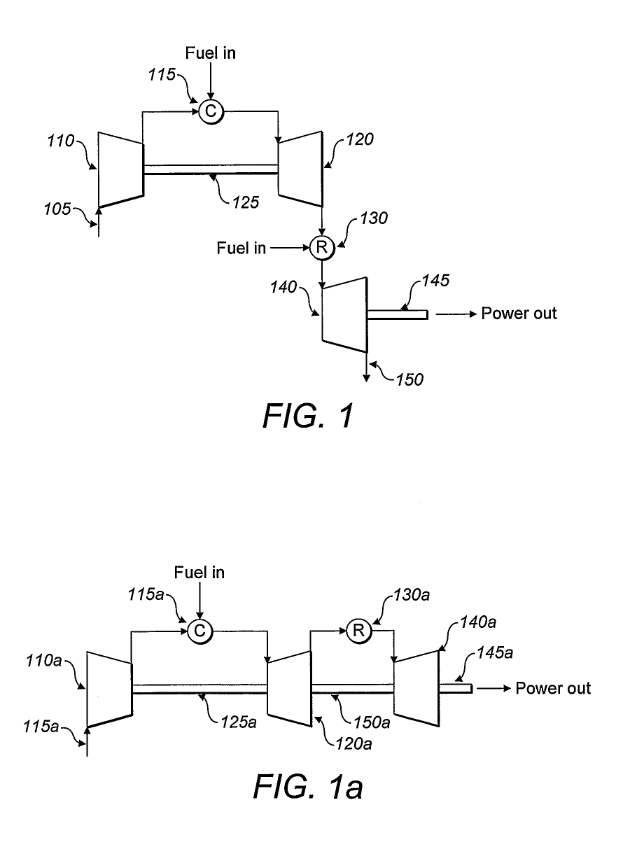

FIG. 1 shows a schematic representation of a first embodiment of a gas turbine according to the present invention;

FIG. 1a shows a schematic representation of variant of the first embodiment of a gas turbine according to the present invention;

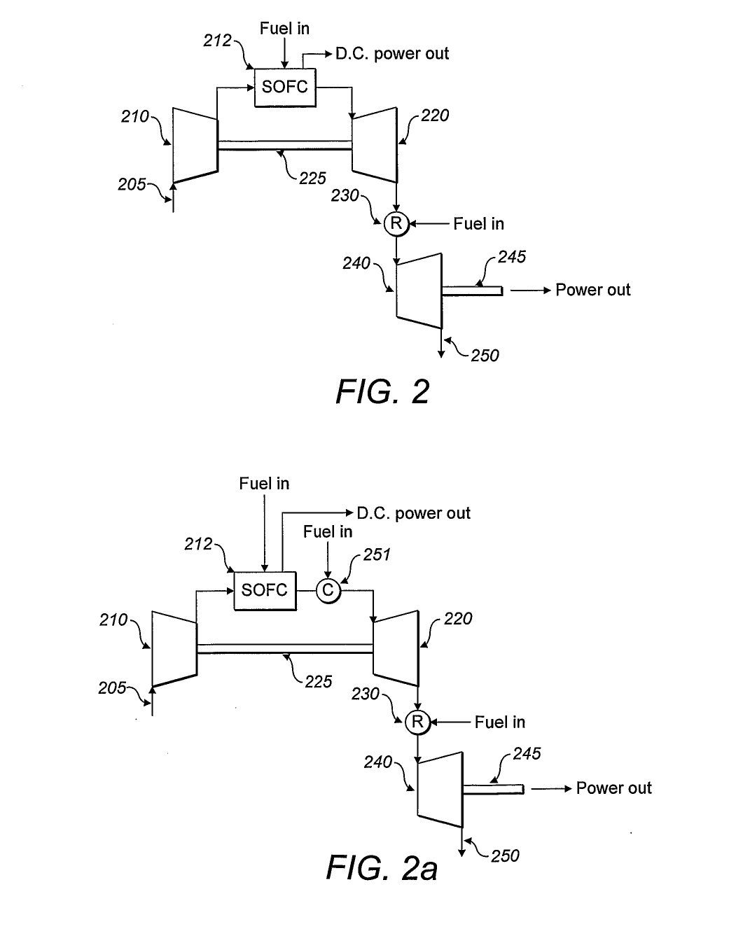

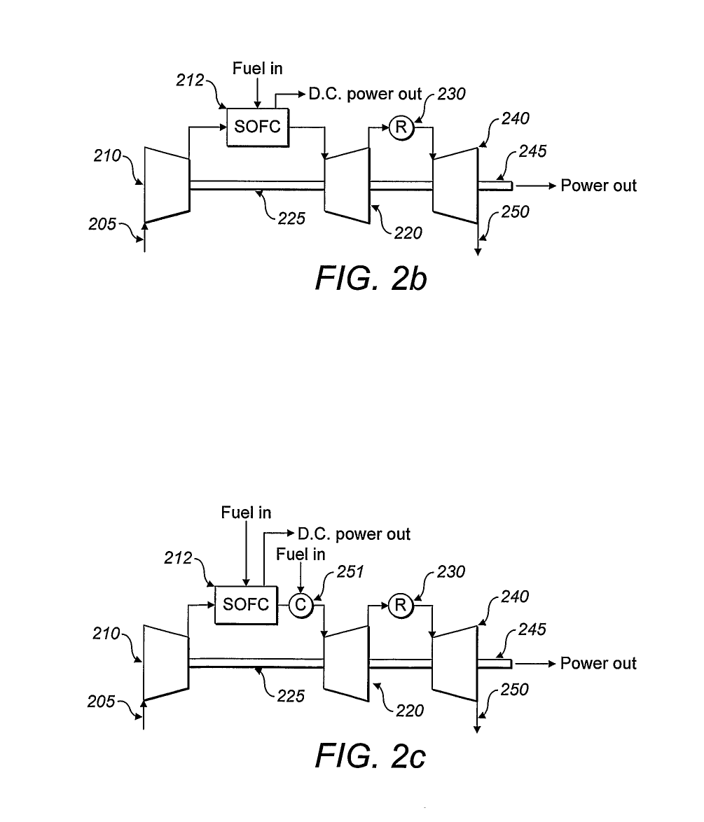

FIG. 2 shows a schematic representation of a second embodiment of a gas turbine system according to the present invention;

FIG. 2a shows a first variant of the FIG. 2 embodiment of a gas turbine system;

FIG. 2b shows a second variant of the FIG. 2 embodiment of a gas turbine system;

FIG. 2c shows a third variant of the FIG. 2 embodiment of a gas turbine system;

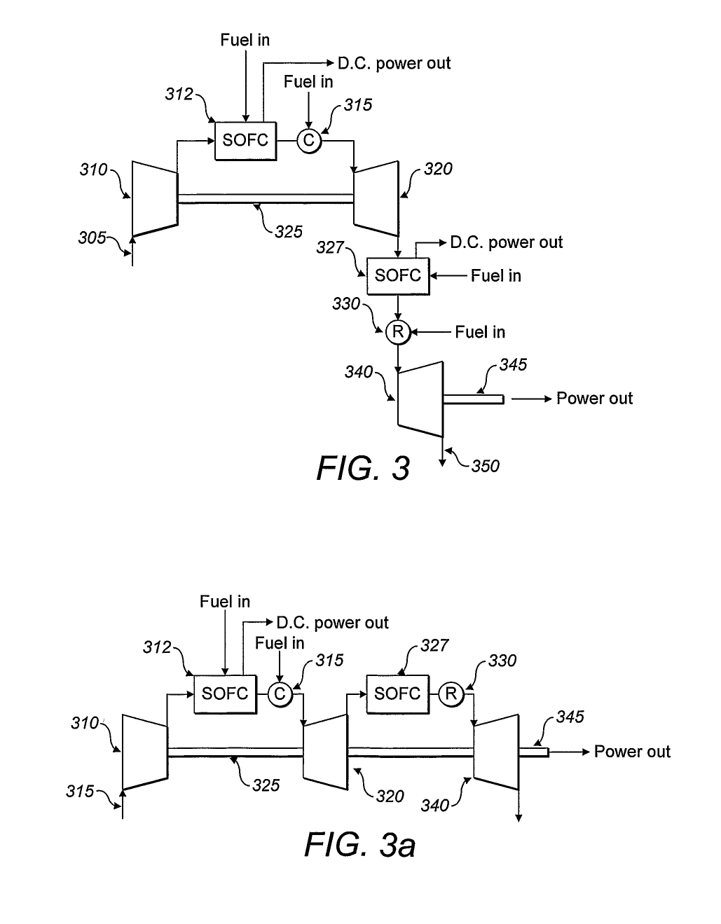

FIG. 3 shows a schematic representation of a third embodiment of a gas turbine system according to the present invention;

FIG. 3a shows a first variant of the FIG. 3 embodiment of a gas turbine system;

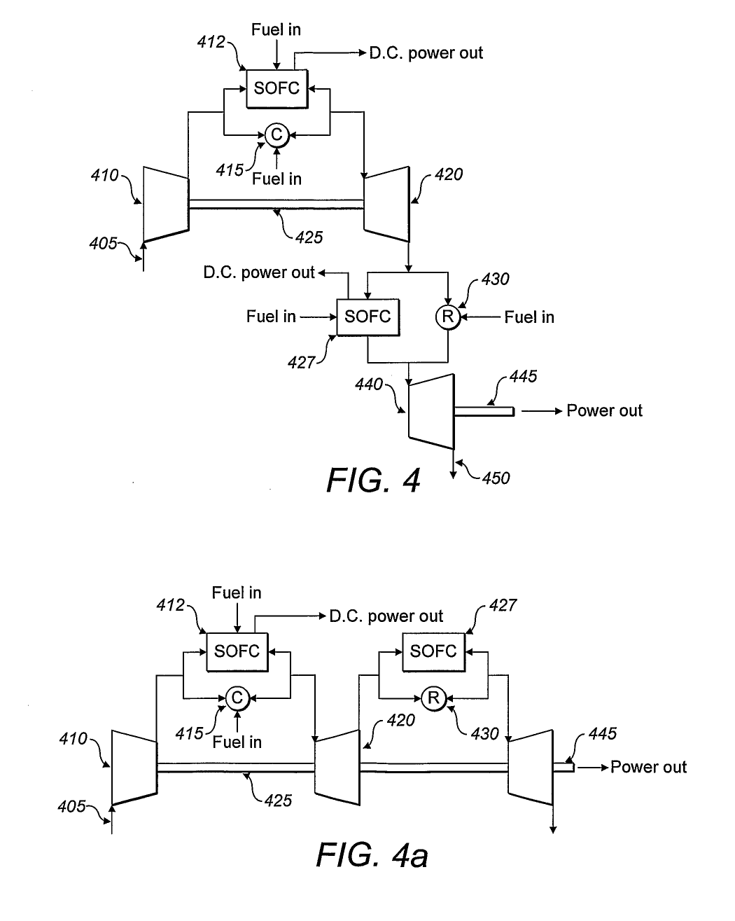

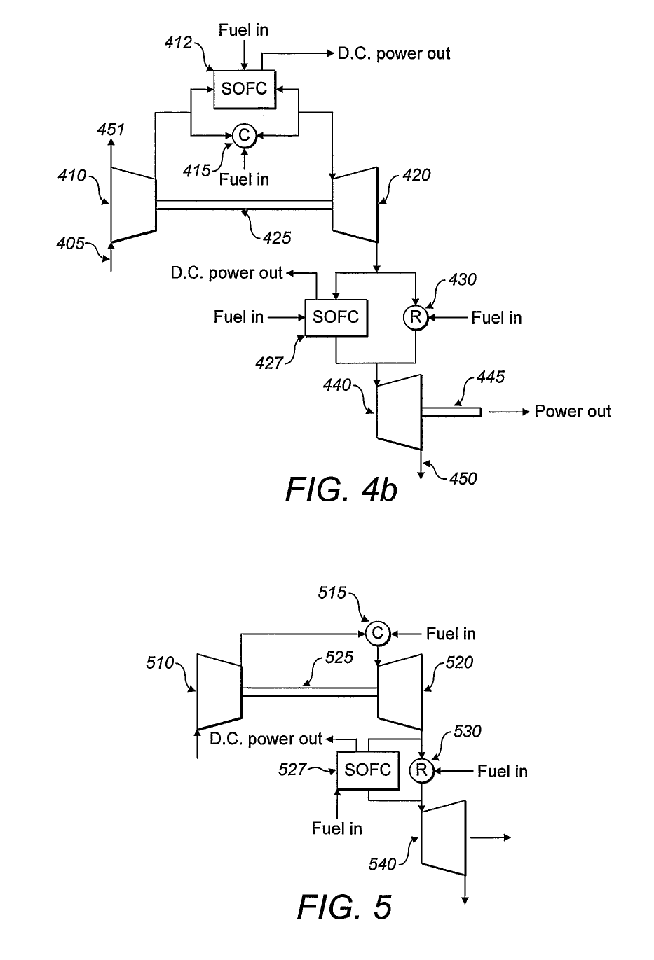

FIG. 4 shows a schematic representation of a fourth embodiment of a gas turbine system according to the present invention;

FIG. 4a shows a first variant of the FIG. 4 embodiment of a gas turbine system;

FIG. 4b shows a second variant of the FIG. 4 embodiment of a gas turbine system;

FIG. 5 shows a schematic representation of a fifth embodiment of a gas turbine according to the present invention for use in an aircraft; and

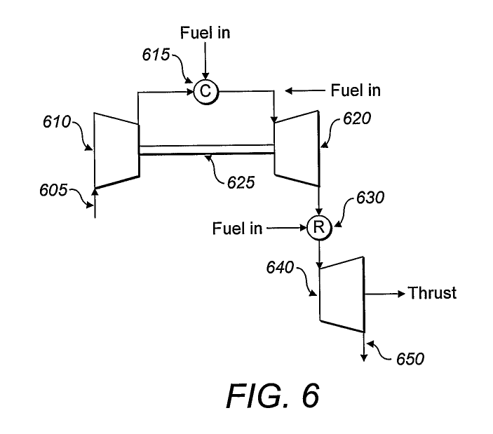

FIG. 6 shows a schematic representation of a sixth embodiment of a gas turbine according to the present invention for use in an aircraft.

In FIG. 1 there can be seen a reheated gas turbine system comprises a high pressure turbine stage having a high pressure compressor 110, driven by a high pressure turbine 120 via a shaft 125. The high pressure turbine 120 is supplied with combusted gas from an upstream combustion chamber 115 (located upstream of the high pressure turbine 120). The upstream combustion chamber 115 receives a supply of compressed gas from the high pressure compressor 110 and a supply of fuel from an external fuel source (not shown).

The high pressure turbine 120 provides a supply of gas to a downstream combustion chamber 130 (located downstream of the high pressure turbine 20). The downstream combustion chamber 130 also receives a supply of fuel from an external fuel source (not shown).

Downstream combustion chamber 130 provides a supply of combusted gas to output turbine 140, which drives output shaft 145.

In use, gas is supplied at an inlet 105 to the high pressure compressor 10. The compressor is driven by the rotation of shaft 125 to compress the gas. The compressed gas is then supplied to the upstream combustion chamber 115, wherein it is mixed with fuel, such as kerosene, propane, natural gas, or the like, and ignited. The combusted gas is then supplied to the high pressure turbine 120. In the high pressure turbine 120 the gas expands. The expansion drives the high pressure turbine 120, thereby driving the shaft 125. The expanded gas leaves the high pressure turbine 120 and is supplied to the downstream combustion chamber 130, wherein it is again mixed with fuel, such as kerosene, propane, natural gas, or the like, and ignited. This combusted gas is then supplied to the output turbine 140, where it expands, driving the output turbine 140. The output turbine 140 provides a mechanical work output by driving an output shaft 145. The gas is expelled from the turbine system via outlet 150.

The turbine system has two combustion chambers 115, 130, respectively supplying the high pressure turbine and the output turbine. Conventional gas turbine theory dictates that in a reheated gas turbine system the highest cycle efficiency is achieved by operating both combustion chambers to produce turbine inlet temperatures for the two turbines which are identical and as high as possible. The limit temperature is often dictated by the physical properties of the materials from which the high pressure turbine and output turbine are constructed and the turbines are manufactured both to have an equally high temperature limit. Since, conventionally, the two turbines 120, 140 would be made of the same materials, the cost of the power plant as a whole comprises the cost of two turbines with equally high temperature limits.

In contrast to the conventional approach, the combustion chambers of the first embodiment are configured and arranged to supply combusted gas at different temperatures.

The upstream combustion chamber supplies the high pressure turbine with gas at a high-pressure turbine inlet temperature. The downstream combustion chamber supplies the output turbine with gas at an output turbine inlet temperature, which is higher than the high-pressure turbine inner temperature. Specifically, in this embodiment, the output turbine inlet temperature is as high as possible, whereas the high-pressure turbine inlet temperature is at a lower temperature. Accordingly, the high pressure turbine is subjected to lower thermal stress and can therefore be manufactured from materials that are less expensive.

A typical inlet temperature range for the turbine 120 would be 600°-1000° C. The temperature of gas at the inlet of the output turbine 140 would be 1400° C. Output (or power) turbine 140 will operate with a significantly higher expansion ratio than the high pressure (or “gas generator”) turbine 120. It is under high mechanical stress and must operate at high temperatures and thus must be a well-engineering and relatively expensive component. Conversely, the high-pressure turbine 120 operates with a significantly lower expansion ratio and with a lower operating temperature, typically within the capabilities of current internal combustion turbocharger technology; it can be a relatively low cost item.

Preferably the downstream combustion chamber 130 can be deactivated by the system in selected operating conditions, while the compressor 110, combustion chamber 115 and turbines 120, 140 remain active. This can be useful in a hybrid drive system for a vehicle. The drive system can have a first operating mode in which the downstream combustion chamber 130 is active (while the compressor 110, combustion chamber 115 and turbines 120,140 are also active and in operation) and mechanical power from the output turbine 140 is relayed by a mechanical transmission to e.g. drive wheels of an automobile, with the electrical power generated by the SOFC 215 used e.g. to recharge batteries of the vehicle (or drive electric motors of the vehicle). The drive system can be also have a second operating mode in which the downstream combustion chamber 30 is inactive (while the compressor 110, combustion chamber 115 and turbines 120,140 remain active) and the turbine 40 is decoupled by the mechanical transmission from the wheels and coupled instead to an electrical generator; thus in the second mode the SOFC will produce DC electrical power and the generator coupled to the turbine 40 will produce AC electrical power.

As mentioned above, conventional systems will be arranged to maintain the turbine inlet temperatures so that they are equal and as high as possible. In practical applications, the turbine inlet temperatures will only be controlled to a certain tolerance. In other words, random fluctuations in inlet temperatures are possible in existing systems. Consequently, there may exist slight differences in turbine inlet temperatures, but these will only be small. However, such systems would still be considered to be configured to maintain equal turbine inlet temperatures. Any differences in turbine inlet temperatures are incidental. Incidental differences in inlet temperature will be less than 50° C. for a turbine operating at 1400° C. In percentage terms, this is approximately 3.5%.

In contrast to conventional systems, embodiments of the present invention are intentionally configured to have different turbine inlet temperatures. The difference may be predetermined as a function of the materials and structure of the high-pressure turbine 20 and output turbine 40. Alternatively, the difference may be predetermined as a function of the means used to introduce heat downstream of the high-pressure turbine 20. For example as a function of the maximum output temperature of a SOFC.

In preferred embodiments the difference will be greater than 50° C. (3.5% for a turbine operating at 1400° C.). In further preferred embodiments, such as those incorporating a SOFC 215, the difference will be greater than 400° C. (28% for a turbine operating at 1400° C.).

Calculations have shown that for a reheated turbine plant such as shown in FIG. 1 and assuming an inlet temperature of 1390° C. for the turbine 40 then the thermal efficiency of the plant reduces by approximately 1.5% with every 100° C. reduction of the inlet temperature of the turbine 20 from the 1390° C. ideal. The brake specific fuel consumption increases also by about 1.5% for every 100° C. reduction of the inlet temperature of turbine 20 from the ideal 1390° C. Thus the proposal of the invention goes against accepted theory, but the applicant believes that the cost saving and simplification made possible by the present invention will allow much more widespread use of reheated gas turbine plants and that this advantage outweighs the loss of efficiency.

Although in the FIG. 1 embodiment the turbines 120 and 140 are provided with different shafts 125, 145, the turbines could be arranged on a common shaft. This is shown in FIG. 1a, where components equivalent to the components of FIG. 1 are given the same reference numeral, but with the suffix ‘a’. The reference numerals 125a and 150a refer to different sections of a shaft common to all of the compressor 110a, the turbine 120a and the turbine 140. The free power turbine 140 of FIG. 1 is preferred when the system is subject to rapid load changes. If the system is for operation at a steady state then the common shaft arrangement of figure a is preferred since it is more efficient (e.g. it requires less bearings for shaft support) and can packaged more easily in a smaller overall volume. However, the FIG. 1a variant is slow to respond (there is greater inertia with all of the compressor and the two turbines on a common shaft) and so the FIG. 1 variant is preferred for use in vehicles.

Although in the above-described first embodiment the compressed gas exiting the high pressure compressor 110 is heated by a combustion process within a upstream combustion chamber 115, since the inlet temperature of the high pressure turbine 120 is not maximised, the upstream combustion chamber 115 may be replaced with an alternative heat source. For example, as shown in FIG. 2, a Solid Oxide Fuel Cell (SOFC) 212 may be used instead of the upstream combustion chamber 115.

FIG. 2 shows a reheated gas turbine system in accordance with a second embodiment of the invention.

The reheated gas turbine system comprises a high pressure turbine stage having a high pressure compressor 210, driven by a high pressure turbine 220 via a shaft 225.

The high pressure compressor 210 provides a supply of compressed gas to an upstream SOFC 212 (upstream of the high pressure turbine 220). The SOFC 212 directly provides a supply of heated compressed gas to the high pressure turbine 220. In this embodiment the SOFC 212 directly communicates, that is without any intermediate combustion chamber, with the high pressure turbine 220.

The SOFC 212 is provided with a supply of fuel from an external fuel source (not shown).

The high pressure turbine 220 provides a supply of gas to a downstream combustion chamber 230 (downstream of the high pressure turbine 220). The downstream combustion chamber 230 receives a supply of fuel from an external fuel source (not shown).

The downstream combustion chamber 230 provides a supply of combusted gas to an output turbine 240, which provides mechanical power output by driving an output shaft 245.

In use, gas is supplied at an inlet 205 to the high pressure compressor 210. The compressor is driven by the rotation of shaft 225 to compress the gas. The compressed gas is then supplied to the upstream SOFC 212, wherein it is heated. SOFCs generally operate with highest efficiency when pressurized.

The heated gas is then supplied to the high pressure turbine 220. In the high pressure turbine 220 the gas expands. The expansion drives the high pressure turbine 220, thereby driving the shaft 225. The expanded gas leaves the high pressure turbine 220 and is supplied to the combustion chamber 230, wherein it is mixed with fuel, such as kerosene, propane, natural gas, or the like, and ignited. This combusted gas is then supplied to the output turbine 240, where it expands, driving the output turbine 240 and thereby driving output shaft 245. The gas is expelled from the turbine system via outlet 250.

In the above-described second embodiment, the gas communicated between the outlet of the high pressure compressor 210 and the inlet of the high pressure turbine 220 is heated solely by a SOFC 212.

A SOFC cannot heat the gas to as high a temperature as a conventionally used combustion chamber. Consequently, it is not necessary to use a high cost high pressure turbine manufactured from expensive heat resistant materials. A typical temperature range for a SOFC would be 600°-1000° C. The temperature of gas at the inlet of the turbine 40 would be 1400° C. Output (or power) turbine 240 will operate with a significantly higher expansion ratio than the high pressure (or “gas generator”) turbine 220. It is under high mechanical stress and must operate at high temperatures and thus must be a well-engineering and relatively expensive component. Conversely the turbine 220 operates with a significantly lower expansion ratio and with a lower operating temperature, typically within the capabilities of current internal combustion turbocharger technology; it can be a relatively low cost item.

Preferably the combustion chamber 230 can be deactivated by the system in selected operating conditions, whilst the SOFC 12, compressor 210, turbine 220 and turbine 240 all remain in operation. This can be useful in a hybrid drive system for a vehicle. The drive system can have a first operating mode in which the combustion chamber 230 is active (and the SOFC 212, compressor 210 and turbines 220, 240 are also active and in operation) and mechanical power from the turbine 240 is relayed via shaft 245 and a mechanical transmission (not shown) to e.g. drive wheels of an automobile, with the electrical power generated by the SOFC used e.g. to recharge batteries of the vehicle (or drive electric motors of the vehicle). The drive system can also have a second operating mode in which the combustion chamber 230 is inactive (whilst the SOFC 212, compressor 210, turbine 220 and turbine 240 remain active and in operation) and the turbine 240 is decoupled by the mechanical transmission from the wheels and coupled instead to an electrical generator; thus in the second mode the SOFC will produce DC electrical power and the generator coupled to the turbine 240 will produce AC electrical power. In an alternative scheme of operation the shaft 245 connects the turbine 240 only to an electric generator and electric motors alone used to drive the vehicle; the electric power is generated either by the SOFC 212 alone or by both the SOFC 212 and the generator powered by the turbine 240, e.g. when greater power is needed—the combustion chamber 240 could be made active only in high power situations, when the turbine 240 drives the electric generator (the SOFC 212, compressor 210 and turbines 220, 240 remain active and in operation whether the combustion chamber 240 is active or inactive).

A variant of the FIG. 2 embodiment is shown in FIG. 2a. The variant is identical to the FIG. 1 embodiment except that an additional combustion chamber 251 is connected between the SOFC 212 and turbine 220, to supply additional heat to the gas leaving the SOFC 212 prior to combustion of the gas in the turbine 220. The combustion chamber 251 could be operated continuously or selectively only when power demanded of the gas turbine system exceeds a pre-set threshold. The use of the combustion chamber 251 could reduce constraints on the design of the SOFC 212, in reducing the amount of heat that the SOFC has to add to the compressed gas.

Whilst FIGS. 2 and 2a both show the output turbine 240 as a free power turbine mounted on an independent output shaft 245, the power turbine could be mounted a shaft common to all of the compressor 210, turbine 220 and turbine 240. this is shown in FIG. 2c, which illustrates how the FIG. 2 system would be configured with a common shaft, and in FIG. 2d, which shows how the FIG. 2b system would be configured with a common shaft. The advantages and disadvantages of free power turbine and common shaft arrangements are discussed above.

FIG. 3 shows a reheated gas turbine system in accordance with a third embodiment of the invention.

The reheated gas turbine system comprises a high pressure turbine stage having a high pressure compressor 310, driven by a high pressure turbine 320 via a shaft 325. The high pressure turbine 320 is supplied with combusted gas from a upstream combustion chamber 315 (upstream of the high pressure turbine 320).

The high pressure compressor 310 provides a supply of compressed gas to an upstream SOFC 312 (upstream of the high pressure turbine 320). The upstream SOFC 312 provides a supply of heated compressed gas to the first combustion chamber 315.

The upstream SOFC 312 is provided with a supply of fuel from an external fuel source (not shown). The upstream combustion chamber 315 is also provided with a supply of fuel from an external fuel source (not shown).

The high pressure turbine 320 provides a supply of gas to a downstream SOFC 327 (downstream of the high pressure turbine 320). The downstream SOFC 327 provides a supply of gas to a downstream combustion chamber 330. The downstream SOFC 327 receives a supply of fuel from an external fuel source (not shown). The downstream combustion chamber 330 also receives a supply of fuel from an external fuel source (not shown).

Downstream combustion chamber 330 provides a supply of combusted gas to output turbine 340, which drives output shaft 345.

In use, gas is supplied at an inlet 305 to the high pressure compressor 310. The compressor is driven by the rotation of shaft 325 to compress the gas. The compressed gas is then supplied to the upstream SOFC 327, wherein it is heated.

The compressed gas is then supplied to the upstream combustion chamber 315, wherein it is mixed with fuel, such as kerosene, propane, natural gas, or the like, and ignited. The combusted gas is then supplied to the high pressure turbine 320. In the high pressure turbine 320 the gas expands. The expansion drives the high pressure turbine 320, thereby driving the shaft 325. The expanded gas leaves the high pressure turbine 220 and is supplied to the downstream SOFC 327, where it is heated further. The gas is then supplied to the downstream combustion chamber 330, wherein it is again mixed with fuel, such as kerosene, propane, natural gas, or the like, and ignited. This combusted gas is then supplied to the output turbine 340, where it expands, driving the output turbine 340 and thereby driving output shaft 345. The gas is expelled from the turbine system via outlet 350.

Like in the above embodiments, the output (or power) turbine 350 operates with a higher expansion ratio than the high pressure (or “gas generator”) turbine 320 and with a higher inlet temperature. The output turbine is connected by a shaft 345 to drive wheels of a vehicle and/or an electrical generator.

In the above described third embodiment, the SOFCs and combustion chambers are arranged in a series configuration.

Whereas the series configuration disclosed in the above-described third embodiment includes an SOFC before a combustion chamber in the direction of gas flow, it is equally possible to provide the SOFC after the combustion chamber in the direction of gas flow. The SOFC and the combustion chamber can be provided in this order either before the high pressure turbine or after the high pressure turbine and before the output turbine.

The use of a second SOFC to provide reheat allows operation of the plant with high efficiency and a high power output across a broad range of operating conditions. If the gas turbine system is used in a hybrid vehicle then the first and second combustion chambers 315 and 330 could be made controllable so that the plant could be operated in a first mode with both combustion chambers 315, 330 active (and both SOFC's 312, 327 active, the compressor 312 active and the turbines 320, 340 active) and the turbine 240 connected to driven wheels of a vehicle and a second mode with the combustion chambers 315,330 inactive (but with the SOFC's 312, 327, the compressor 310 and the turbines 320, 340 remaining active) and the turbine 340 disconnected from the driven wheels (and perhaps connected to an electrical generator to generate AC power); in this mode the SOFC 312 and SOFC 327 would supply DC power. A third operating mode is also possible, in which only the combustion chamber 330 is deactivated (and the SOFC's 312, 327 remain active along with the combustion chamber 315, the compressor 310 and the turbines 320, 340) and in which the turbine 340 is disconnected from the driven wheels (and preferably connected to an electrical generator to generate AC power); the SOFC 312 and the SOFC 327 will both generate DC power to charge batteries or drive electric motors. The use of the combustion chambers 315,330 can provide power for acceleration of the vehicle and/or for high vehicle cruising speeds.

Whilst FIG. 3 shows the output turbine 340 as a free power turbine mounted on an independent output shaft 345, the power turbine could be mounted a shaft common to all of the compressor 310, turbine 320 and turbine 340. This is shown in FIG. 3a, which illustrates how the FIG. 3 system would be configured with a common shaft. The advantages and disadvantages of free power turbine and common shaft arrangements are discussed above.

FIG. 4 shows a reheated gas turbine system in accordance with a further embodiment of the invention.

The reheated gas turbine system comprises a high pressure turbine stage having a high pressure compressor 410, driven by a high pressure turbine 420 via a shaft 425.

The high pressure compressor 410 provides a supply of compressed gas which is divided into two paths. A first path supplies compressed gas to an upstream SOFC 412 (upstream of the turbine 420). A second path supplies compressed gas to the an upstream combustion chamber 415 (upstream of the turbine 420).

The upstream SOFC 412 is provided with a supply of fuel from an external fuel source (not shown). The upstream combustion chamber 415 is also provided with a supply of fuel from an external fuel source (not shown).

The heated gas from the upstream SOFC 412 and the combusted gas from the upstream combustion chamber 415 merge into a single path to supply the high pressure turbine 420.

The high pressure turbine 420 provides a supply of gas which is divided into two paths. A first path supplies compressed gas to a downstream SOFC 427 (downstream of the turbine 420). A second path supplies compressed gas to the downstream combustion chamber 430 (downstream of the turbine 420).

The downstream SOFC 427 is provided with a supply of fuel from an external fuel source (not shown). The downstream combustion chamber 430 is also provided with a supply of fuel from an external fuel source (not shown).

The heated gas from the downstream SOFC 427 and the combusted gas from the downstream combustion chamber 430 merge into a single path to supply the output turbine 440, which drives output shaft 445.

In use, gas is supplied at an inlet 405 to the high pressure compressor 410. The compressor is driven by the rotation of shaft 425 to compress the gas. The compressed gas is then supplied to both the upstream SOFC 412, wherein it is heated, and the upstream combustion chamber 415, wherein it is mixed with fuel and ignited.

The combined flow of both the heated gas, from the upstream SOFC 412, and the combusted gas, from the upstream combustion chamber 415, is then supplied to the high pressure turbine 420. In the high pressure turbine 320 the gas expands. The expansion drives the high pressure turbine 420, thereby driving the shaft 425. The expanded gas leaves the high pressure turbine 420 and is divided into two paths, leading to the downstream SOFC 427, and the downstream combustion chamber 430, respectively. In the downstream SOFC 427 the expanded gas is heated and in the downstream combustion chamber 430 the gas is mixed with fuel and ignited.

The combined flow of both the heated gas, from the final SOFC 427, and the combusted gas, from the final combustion chamber 430, is then supplied to the output turbine 440, where it expands, driving the output turbine 440 and thereby driving output shaft 445. The gas is expelled from the turbine system via outlet 450.

In the above described FIG. 4 embodiment, SOFCs and combustion chambers are arranged in a parallel configuration.

It may be preferable to adopt a parallel arrangement of SOFC's and combustion chambers when it is desired to allow for deactivation of the combustion chambers 415, 430 while leaving active the SOFC's 412, 430, the compressor 410 and the turbines 420, 440; valving can be incorporated in the flow path to direct all gas flow to the SOFC's in such a condition.

Whilst FIG. 4 shows the output turbine 440 as a free power turbine mounted on an independent output shaft 445, the power turbine 440 could be mounted a shaft common to all of the compressor 410, turbine 420 and turbine 440. This is shown in FIG. 4a, which illustrates how the FIG. 4 system would be configured with a common shaft. The advantages and disadvantages of free power turbine and common shaft arrangements are discussed above.

Any of the plants described above could be combined with a reciprocating piston or rotary engine, e.g. a pressure charged diesel engine or pressure charged spark ignition engine. The expanded air leaving the second turbine 140,240,340,440 could be supplied to such an engine in order to compression charge the engine. Alternatively any of the previously described embodiments could be adapted to supply compressed charge air to an engine from the compressor 110, 210, 310, 410; by way of example this is illustrated in FIG. 4b which shows a variant of the FIG. 4 system in which a supply line 451 is shown taking compressed air from compressor 410 to be supplied as charged air to an internal combustion engine.

The ability to reheat the partially-combusted air flowing out of the high pressure turbines 120,220,320,420 above allows more power to be extracted from the plant. While there may be a loss of efficiency in some areas, the brake specific air consumption of the plant as a whole is reduced by the reheating, leading to higher power output from the same size of plant.

In the embodiments of FIGS. 3,3a, 4 and 4a described above, the reheated gas turbine system has two heating stages, each comprising a SOFC and a combustion chamber, in either series or parallel configurations. The first heating stage could comprise the first SOFC and the first combustion chamber in one configuration (series or parallel) and the second heating stage could comprise the second SOFC and the second combustion chamber in the opposite configuration (series or parallel). Furthermore, embodiments of the invention are not limited to only having two heating stages and one intermediate turbine stage followed by one output turbine, but can be applied to reheated gas turbine systems having any number of heating stages and turbine stages. In these embodiments, any configuration of an SOFC and a combustion chamber is possible in each heating stage.

As will be appreciated by the skilled person, the above disclosed embodiments can equally be applied to a propulsion system utilising an output nozzle in place of the output turbine described above. An example of this is shown in a first embodiment of the present invention, illustrated in FIG. 5, of particular use in aircraft applications.

In the FIG. 5 embodiment air is compressed by a compressor stage 510 and then the compressed air delivered to an upstream combustion chamber 515 to which a hydrocarbon fuel is supplied, with the resulting hot post-combustion gases supplied to a turbine 520 in which expansion takes places, the turbine 520 being connected to drive the compressor 510 via a shaft 425. The expanded gases then pass through a parallel arrangement of a downstream SOFC 527 and a downstream reheat combustion chamber 530, both of which are supplied with fuel. The reheated gases are then expanded in an output turbine stage 540 which is an output nozzle (which is a turbojet, turbofan or turboshaft aircraft engine, having one or more spools).

The FIG. 1 embodiment is shown in FIG. 6 modified as a propulsion system, e.g. of an aircraft, which has an output nozzle 640 in place of the output turbine 140 described above. The output nozzle 340 outputs thrust for propelling the vehicle, e.g. aircraft.

In both of the FIGS. 5 and 6 embodiments the upstream combustion chamber supplies the high pressure turbine with gas at a high-pressure turbine inlet temperature. The downstream combustion chamber supplies the output turbine with gas at an output turbine inlet temperature, which is higher than the high-pressure turbine inner temperature. Specifically, the output turbine inlet temperature is as high as possible, whereas the high-pressure turbine inlet temperature is at a lower temperature. Accordingly, the high pressure turbine is subjected to lower thermal stress and can therefore be manufactured from materials that are less expensive.

Whilst solid oxide fuel cells have been described above, other types of fuel cells could be used.

Whilst not shown, a heat exchanger could be inserted into any of the gas turbine systems illustrated in a manner well known in the art.

1. A gas turbine system comprising:
a gas compressor;
an upstream fuel cell which receives gas compressed by the compressor and which generates electrical power and heats the gas passing therethrough;
an intermediate turbine which receives the gas previously heated in the upstream fuel cell and which is connected to and drives the compressor; and
an output turbine which receives gas output by the intermediate turbine; wherein:
expanded gas leaving the intermediate turbine passes to the output turbine through either or both of a downstream combustion chamber and/or a downstream fuel cell, whereby the expanded gas is reheated prior to expansion in the output turbine.

2. A gas turbine system as claimed in claim 1 comprising additionally an upstream combustion chamber which is arranged in parallel with the upstream fuel cell which receives and heats the gas compressed by the compressor.

3. A gas turbine system as claimed in claim 1 comprising additionally an upstream combustion chamber which is arranged in series with the upstream fuel cell and which receives and heats the gas compressed by the compressor.

4. A gas turbine system as claimed in any one of claims 1 to 3 wherein both a downstream combustion chamber and downstream fuel cell are arranged in parallel between the intermediate turbine and the output turbine.

5. A gas turbine system as claimed in any one of claims 1 to 3 wherein both a downstream combustion chamber and downstream fuel cell are arranged in series between the intermediate turbine and the output turbine.

6. A gas turbine system as claimed in any one of the preceding claims wherein the or at least one of the combustion chamber(s) can be selectively activated and deactivated while the fuel cell(s), the compressor and the turbine(s) remain operational.

7. A gas turbine system comprising:
a gas compressor;
an upstream combustion chamber which receives gas compressed by the compressor and which heats the gas passing therethrough;
an intermediate turbine which receives the heated gas leaving the first combustion chamber and which is connected to and drives the compressor; and
an output turbine which receives the gas output by the intermediate turbine stage; wherein
expanded gas leaving the intermediate turbine passes to the output turbine through a downstream fuel cell, whereby the expanded gas is reheated prior to expansion in the output turbine.

8. A gas turbine system as claimed in claim 8 comprising additionally a downstream combustion chamber arranged in parallel with the downstream fuel cell.

9. A gas turbine system as claimed in claim 7 comprising additionally a downstream combustion chamber arranged in series with the downstream fuel cell.

10. A gas turbine system as claimed in claim 8 or claim 9 wherein the downstream combustion chamber can be selectively activated and deactivated.

11. A gas turbine system as claimed in any one of the preceding claims where the intermediate turbine operates with a first inlet temperature and a first expansion ratio and the output turbine operates with a second inlet temperature higher than the first inlet temperature and a second expansion ratio greater than the first expansion ratio.

12. A hybrid land vehicle having at least one electric motor for driving at least one driven wheel thereof, batteries to store electrical power, a gas turbine system as claimed in claim 6 or claim 11 and a transmission system which can selectively connect the output turbine of the gas turbine system to a/the driven wheel and a controller which controls operation of the electric motor, the gas turbine system and the transmission system, wherein the controller can select between at least the following first and second operating conditions of the vehicle:
a first operating condition in which the electric motor drives the driven wheel(s), at least one combustion chamber of the gas turbine system is deactivated, the transmission system decouples the output turbine stage from the wheel driven thereby and the fuel cell(s) of the gas turbine system generate(s) electricity to power to electric motor; and
a second operating condition in which all combustion chambers of the gas turbine system are activated, the transmission system couples the output turbine stage to the wheel(s) driven thereby and the output turbine is used to drive the driven wheel(s) while the fuel cell(s) of the gas turbine system generate electricity to charge the batteries or power the electric motor, in which second condition the driven wheels can be driven either by the output turbine alone or acting in tandem with the electric motor.

13. A hybrid land vehicle as claimed in claim 12 comprising additionally an electrical generator which can be coupled to the output turbine stage of the gas turbine system by the transmission system and in the first operating condition the transmission system decouples the output turbine stage from the wheel driven thereby and couples the output turbine stage to the electrical generator, which generates electricity to power the electric motor, and in the second operating condition the mechanical transmission couples the output turbine stage to the wheel(s) driven thereby and decouples the output turbine stage for the electrical generator.

14. A hybrid land vehicle having at least one electric motor for driving at least one driven wheel thereof, batteries to store electrical power, an electrical generator, a gas turbine system as claimed in claim 6 or claim 11, a transmission system which can selectively connect the output turbine of the gas turbine to the electrical generator and a controller which controls operation of the gas turbine system and the transmission system, wherein the controller can select between at least the following first and second operating conditions of the vehicle:
a first operating condition in which at least one combustion chamber of the gas turbine system is deactivated, the transmission system decouples the output turbine stage from the electrical generator and the fuel cell(s) of the gas turbine system generate(s) electricity to power the electric motor; and
a second operating condition in which all combustion chambers of the gas turbine system are active, the transmission system couples the output turbine stage to the electrical generator and drives the electrical generator to produce electrical power to power the electric motor and the fuel cell(s) of the gas turbine system also generate electricity to charge the batteries and/or power the electric motor, which drives the driven wheel(s).

15. A vehicle comprising a combination of a gas turbine as claimed in any one of claims 1 to 11 with a compression ignition or spark ignition internal combustion engine, wherein the gas turbine system is used to supply pressurised air as the intake air of the internal combustion engine.

16. An aircraft comprising a gas turbine system as claimed in any one of claims 1 to 11 wherein the output turbine functions as or is coupled to a propelling nozzle of the aircraft.

17. A gas turbine system comprising:
a compressor;
an upstream heat source which receives gas compressed by the compressor and which heats the gas passing therethrough;
a high-pressure turbine which receives the heated gas leaving the upstream heat source and which is connected to and drives the compressor;
a downstream combustion chamber which receives gas leaving the high-pressure turbine and which heats the gas passing therethrough; and
an output turbine which receives gas output by the downstream combustion chamber, wherein:
the system is configured such that the temperature of the gas received by the output turbine is higher than the temperature of the gas received by the high-pressure turbine.

18. A gas turbine system according to claim 17, wherein the upstream heat source is a combustion chamber.

19. A gas turbine system according to claim 17 or claim 18, wherein the upstream heat source is a fuel cell.

20. A gas turbine system according to claim 19, wherein the upstream heat source is a solid oxide fuel cell.

21. A gas turbine system according to any one of claims 17 to 20, wherein the system is configured such that the difference in temperature between the gas received by the output turbine and the gas received by the high-pressure turbine is at least 50° C.

22. A gas turbine system according to any one of claims 17 to 20, wherein the system is configured such that the difference in temperature between the gas received by the output turbine and the gas received by the high-pressure turbine is at least 400° C.

23. A gas turbine system according to any one of claims 17 to 20, wherein the output turbine outputs mechanical drive via an output shaft.

24. A land vehicle comprising a gas turbine comprising a gas turbine system as claimed in claim 23, wherein the output shaft is connected to one or more driven wheel(s) of the vehicle.

25. A gas turbine system according to any one of claims 17 to 22, wherein the output turbine comprises a propelling nozzle which provides thrust.

26. An aircraft comprising a gas turbine system as described in claim 25, wherein the thrust is used to propel the aircraft.

27. A hybrid land vehicle comprising a gas turbine system as claimed in claim 19, wherein:
the fuel cell is used to provide electricity to drive (an) electric motor(s) of the vehicle and/or to recharge one or more batteries of the vehicle; and
the output turbine outputs mechanical drive via an output shaft and a transmission is provided to selectively couple the output shaft to one or more driven wheel(s) of the vehicle, the transmission connecting the output shaft to the driven wheel(s) under control of a driver of the vehicle and/or under the control of a vehicle electronic control system.

28. A method of operating a gas turbine system that comprises:
a compressor;
an upstream heat source which receives gas compressed by the compressor and which heats the gas passing therethrough;
a high-pressure turbine which receives the heated gas leaving the upstream heat source and which is connected to and drives the compressor;
a downstream combustion chamber which receives gas leaving the high-pressure turbine and which heats the gas passing therethrough; and
an output turbine which receives gas output by the downstream combustion chamber; wherein
the temperature of the gas received by the output turbine is controlled to be different from the temperature of the gas received by the high-pressure turbine by a predetermined amount.

29. A method of operating a gas turbine system according to claim 28, wherein the temperature of the gas received by the output turbine is controlled to be higher than the temperature of the gas received by the high-pressure turbine.

30. A method of operating a gas turbine system according to claim 28 or claim 29, wherein the predetermined difference is at least 50° C.

31. A method of operating a gas turbine system according to claim 28 or claim 29, wherein the predetermined difference is at least 400° C.
